(19) United States
(12) Patent Application Publication
(10) Pub. No.: US 2021/0234279 A1
(43) Pub. Date: Jul. 29, 2021

(54) CIRCULARLY POLARIZED ANTENNA

(71) Applicant: SZ DJI TECHNOLOGY CO., LTD., Shenzhen (CN)

(72) Inventors: Lu YE, Shenzhen (CN); Dong LI, Shenzhen (CN)

(21) Appl. No.: 17/231,962

(22) Filed: Apr. 15, 2021

Related U.S. Application Data
(63) Continuation of application No. PCT/CN2018/113184, filed on Oct. 31, 2018.

(51) Int. Cl. H01Q 11/08; H01Q 1/36

(52) U.S. Cl. CPC H01Q 11/08; H01Q 1/362

(57) ABSTRACT

A circularly polarized antenna includes a feeding substrate, a radiation structure, and a feeding network. The radiation structure includes a plurality of radiation elements, and each radiation element has a spiral shape. The feeding network includes a feeding port and a balun structure. The feeding port is arranged at the feeding substrate and the balun structure is arranged at a surface of the feeding substrate. The balun structure includes a plurality of baluns, and each balun has a first end electrically coupled to the feeding port and a second end electrically coupled to one of the plurality of radiation elements.

### CROSS-REFERENCE TO RELATED APPLICATION

This application is a continuation of International Application No. PCT/CN2018/113184, filed Oct. 31, 2018, the entire content of which is incorporated herein by reference.

### TECHNICAL FIELD

The present disclosure relates to the technical field of wireless communication and, more particularly, to a circularly polarized antenna.

### BACKGROUND

With the continuous development of society, the performance requirements for antennas are getting higher and higher. In modern wireless application systems, it is difficult for simple linear polarized antennas to meet people's needs, and circularly polarized antennas are getting more and more attention. Because of their special performance, circularly polarized antennas are widely used in communication, remote sensing and telemetry, radar, electronic reconnaissance, electronic interference, etc. However, the sizes of existing circular polarization antennas are generally large, which limits their use.

### SUMMARY

In accordance with the disclosure, there is provided a circularly polarized antenna including a feeding substrate, a radiation structure, and a feeding network. The radiation structure includes a plurality of radiation elements, and each radiation element has a spiral shape. The feeding network includes a feeding port and a balun structure. The feeding port is arranged at the feeding substrate and the balun structure is arranged at a surface of the feeding substrate. The balun structure includes a plurality of baluns, and each balun has a first end electrically coupled to the feeding port and a second end electrically coupled to one of the plurality of radiation elements.

### BRIEF DESCRIPTION OF THE DRAWINGS

FIG. 1 is a schematic perspective view of a circularly polarized antenna according to an embodiment of the present disclosure.

FIG. 2 is a schematic plan view of a balun structure of the circularly polarized antenna of FIG. 1.

FIG. 3 is a schematic plan view of a balun structure of a circularly polarized antenna according to another embodiment of the present disclosure.

FIG. 4 is a schematic perspective view of a circularly polarized antenna according to another embodiment of the present disclosure.

FIG. 5 is a schematic diagram of return loss (S11) of the circularly polarized antenna shown in FIG. 1.

FIG. 6 is a schematic diagram of E-plane total gain of the circularly polarized antenna shown in FIG. 1 at 5.8 GHz.

FIG. 7 is a schematic diagram of E-plane axial ratio of the circularly polarized antenna shown in FIG. 1 at 5.8 GHz.

FIG. 8 is a schematic diagram of return loss (S11) of the circularly polarized antenna shown in FIG. 4.

FIG. 9 is a schematic diagram of E-plane total gain of the circularly polarized antenna shown in FIG. 4 at 2.4 GHz.

FIG. 10 is a schematic diagram of E-plane axial ratio of the circularly polarized antenna shown in FIG. 4 at 2.4 GHz.

FIG. 11 is a schematic diagram of E-plane total gain of the circularly polarized antenna shown in FIG. 4 at 5.8 GHz.

FIG. 12 is a schematic diagram of E-plane axial ratio of the circularly polarized antenna shown in FIG. 4 at 5.8 GHz.

### DETAILED DESCRIPTION OF THE EMBODIMENTS

The technical solutions in the embodiments of the present disclosure will be clearly described with reference to the accompanying drawings. Obviously, the described embodiments are only some of rather than all the embodiments of the present disclosure. Based on the described embodiments, all other embodiments obtained by those of ordinary skill in the art without inventive effort shall fall within the scope of the present disclosure.

It should be noted that when a component is referred to as being “fixed to” another component, it can be directly attached to the other component or an intervening component may also exist. When a component is considered to be “connected” to another component, it can be directly connected to the other component or an intervening component may exist at the same time.

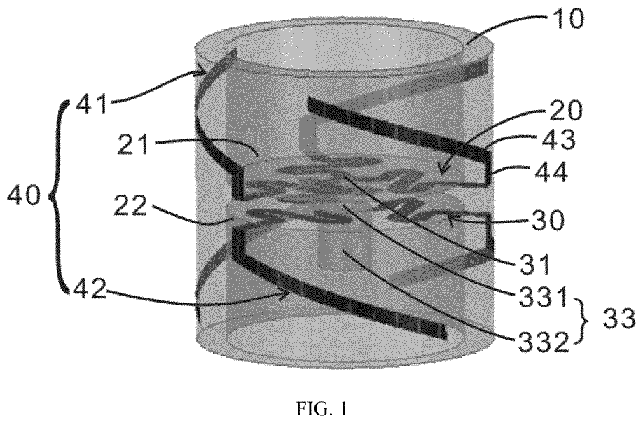

Referring to FIG. 1, the present disclosure provides a circularly polarized antenna 100, which includes a dielectric cylinder 10, a feeding substrate 20, a feeding network 30 and a plurality of radiation elements 40. The plurality of radiation elements 40 form a radiation structure. In some embodiments, the dielectric cylinder 10 has a cylindrical structure. The feeding substrate 20 is a dielectric plate having a front surface 21 and a back surface 22 that are oppositely arranged, where the front surface 21 and the back surface 22 are two opposite surfaces of the feeding substrate 20. The feeding substrate 20 is fixed in the dielectric cylinder 10, and both the front surface 21 and the back surface 22 of the feeding substrate 20 intersect with rotation center axis of the dielectric cylinder 10. The feeding network 30 is arranged at the front surface 21 and the back surface 22 of the feeding substrate 20. The feeding network 30 includes a feeding port 31. In some embodiments, the feeding port 31 is located at the center of the feeding substrate 20, and is coupled with an external device. The radiation elements 40 are spirally arranged at the outer surface of the dielectric cylinder 10, and one end of each radiation element 40 is electrically coupled to the feeding network 30. The feeding network 30 includes a plurality of folded broadband baluns 32, one end of each broadband balun 32 being electrically coupled to one of the radiation elements 40, and the other end being connected to the feeding port 31.

In some embodiments of the present disclosure, the feeding port 31 is a coaxial feeding port, that is, the feeding network 30 feeds power through a coaxial line 33. The coaxial line includes an inner conductor layer 331 and an outer conductor layer 332 sheathed outside the inner conductor layer 331 and coaxial with and insulated from the inner conductor layer 331. The inner conductor layer 331 transmits radiation signals, and the outer conductor layer 332 is grounded.

In the present disclosure, by folding the broadband balun 32 of the feeding network 30, the linear distance from one end to the other end of the broadband balun 32 is reduced, so that the radial dimension of the feeding substrate 20 carrying the feeding network 30 is reduced, thereby reducing the radial dimension of the circularly polarized antenna 100.

In the present disclosure, the circularly polarized antenna 100 is a laser direct structuring (LDS) antenna, that is, the circularly polarized antenna 100 is obtained through an LDS process. Specifically, the dielectric cylinder 10 and the feeding substrate 20 are formed by molding, and then the radiation element 40 is formed on the dielectric cylinder 10 and the feeding network 30 is formed on the feeding substrate 20 by laser technology. Compared with existing method in which the radiation element 40 is first formed on a flexible dielectric plate and then the flexible dielectric plate is bent to form a hollow cylinder, the LDS process is simpler, more stable and reliable. In addition, the circularly polarized antenna 100 is formed through the LDS process, so that the circularly polarized antenna 100 can be obtained by using a dielectric material with a lower dielectric constant compared with the circularly polarized antenna in existing technology, so that the distance between adjacent radiation elements 40 can be smaller compared with existing technology while ensuring normal signal transmission and reception, thereby further reducing the volume of the circularly polarized antenna 100. In some embodiments, the dielectric cylinder 10 has a dielectric constant in the range of 2-5, a height of 5 mm-30 mm, an inner diameter of 10 mm-30 mm, and an outer diameter of 10 mm-30 mm. Of course, materials with larger dielectric coefficients can also be employed, which are not limited here.

In some embodiments, the feeding substrate 20 and the dielectric cylinder 10 are formed of same dielectric material. It can be understood that, in some other embodiments of the present disclosure, the feeding substrate 20 and the dielectric cylinder 10 are made of different materials. In some embodiments, the feeding substrate 20 is a circular plate with a diameter same as the inner diameter of the dielectric cylinder 10, and the center of the feeding substrate 20 locates at the rotation center axis of the dielectric cylinder 10. Also, the front surface 21 is parallel to the back surface 22, and both surfaces are perpendicular to the rotation center axis of the dielectric cylinder 10.

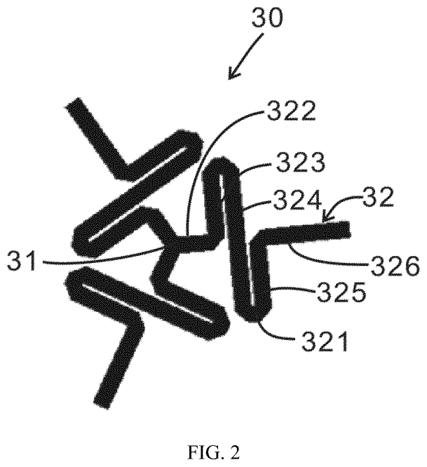

Referring to FIGS. 1 and 2, the feeding network 30 includes balun structures arranged at the front surface 21 and the back surface 22 of the feeding substrate 20 respectively, and the balun structure arranged at the front surface 21 is symmetric to the balun structure arranged at the back surface 22. Each of the balun structures includes a plurality of broadband baluns 32 that are evenly distributed at the feeding substrate 20 with one end being electrically coupled to the feeding port 31. Specifically, one end of each broadband balun 32 of the balun structure on the back surface 22 is electrically coupled to the outer conductor layer 332 of the coaxial line 33 coupled to the feeding port 31, and one end of each broadband balun 32 of the balun structure on the front surface 21 is electrically coupled to the inner conductor layer 331. In some embodiments, each of the balun structures has three broadband baluns 32, one end being electrically coupled to the feeding port 31 for all three broadband baluns 32, and the included angles between two adjacent broadband baluns 32 are all 120°, so that the three broadband baluns 32 are evenly distributed at the feeding substrate 20. It can be understood that, in some other embodiments of the present disclosure, each of the balun structures includes four or more broadband baluns 32 evenly distributed at the feeding substrate 20. In the present disclosure, each of the broadband baluns 32 is a metal strip line including one or more turning points 321. By folding each of the broadband baluns 32 to ensure that the length of the broadband baluns 32 remains unchanged to meet functional requirements, the distance between the two ends of the broadband baluns 32 is shortened, so that the radial dimension of the feeding substrate 20 carrying the feeding network 30 is reduced, thereby reducing the radial dimension of the circularly polarized antenna 100.

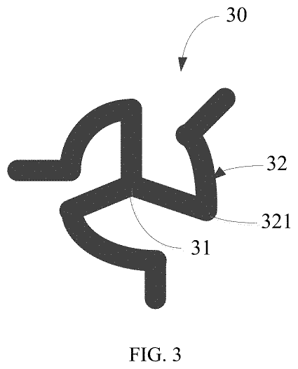

Referring to FIG. 2, in some embodiments, the broadband balun 32 includes a first segment 322, a second segment 323, a third segment 324, a fourth segment 325, and a fifth segment 326 that are connected in sequence, where the connection between two adjacent segments is a turning point 321. In the example shown in FIG. 2, the broadband balun 32 has four turning points 321. Also, in the example shown in FIG. 2, the length of the second segment 323 is the same as the length of the fourth segment 325. It is understandable that in some other embodiments of the present disclosure, depending on actual conditions, the turning points 321 on the broadband balun 32 may also be one or more and there is no restriction on the length of each segment, as long as the performance of the broadband balun 32 is not affected. In the embodiment of FIG. 3, the broadband balun 32 has two turning points 321.

Further, referring to FIG. 1 again, the plurality of radiation elements 40 include a plurality of first radiation elements 41 located on one side of the front surface 21 of the feeding substrate 20 and a plurality of second radiation elements 42 located on one side of the back surface 22 of the feeding substrate 20, one end of each of the first radiation element 41 being electrically coupled to a broadband balun 32 on the front surface 21 of the feeding substrate 20 and one end of each of the second radiation element 42 being electrically coupled a broadband balun 32 on the back surface 22 of the feeding substrate 20. Each of the first radiation elements 41 and a second radiation element 42 are centrosymmetric to each other. A first radiation element 41 and a second radiation element 42 that are centrosymmetric to each other form a symmetrical oscillator, and the center of symmetry is the midpoint between the connection point of the first radiation element 41 to the broadband balun 32 and the connection point of the second radiation element 42 and the broadband balun 32. In the example shown in FIG. 1, there are three symmetrical oscillators, and the three symmetrical oscillators are evenly arranged on the outer surface of the dielectric cylinder 10. That is, the distance between two adjacent symmetrical oscillators on the outer surface of the dielectric cylinder 10 is the same as the distance between two other adjacent symmetrical oscillators on the outer surface of the dielectric cylinder 10.

In the example shown in FIG. 1, a radiation element (the first radiation element 41 or the second radiation element 42) includes a first coupling line 43 and a microstrip line 44 connected to the first coupling line 43, and one end of the microstrip line 44 away from the first coupling line 43 is electrically coupled to one of the broadband baluns 32. The length of the first coupling line 43 is one-fourth of λ1, where λ1 is the wavelength of a first signal, such that the first signal can be received or sent through the first coupling line 43. λ1 is also referred to as a first operation wavelength of the circularly polarized antenna. In some embodiments, the first signal is a signal with a signal frequency of about 5.8 GHz. It can be understood that, in some other embodiments of the present disclosure, the first signal may be a signal with another frequency to meet actual needs. The included angle between two lines respectively connecting the projections of the two ends of the first coupling line 43 on the feeding substrate 20 to the center of the feeding substrate 20 is 70°-110°, so that the circularly polarized antenna 100 has a good circular polarization effect. Of course, the included angle described above is an example, and should not be construed to be a limitation.

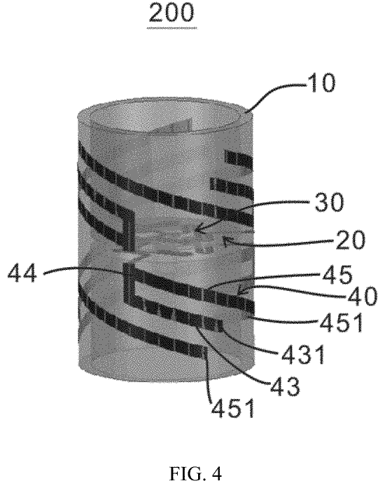

Referring to FIG. 4, the present disclosure also provides a circularly polarized antenna 200. The circularly polarized antenna 200 differs from the circularly polarized antenna 100 of FIG. 1 in that a radiation element (the first radiation element 41 or the second radiation element 42) further includes a second coupling line 45 having the same spiral direction as the first coupling line 43 and a different length than the first coupling line 43, and one end of the second coupling line 45 is connected to the microstrip line 44. The first coupling line 43 includes an open end 431 away from the microstrip line 44, the second coupling line 45 includes an open end 451 away from the microstrip line 44. Relative to the end connected to the microstrip line 44, the open end 451 of the second coupling line 45 is closer to the open end 431 of the first coupling line 43. In some embodiments, the second coupling line 45 is arranged parallel to the first coupling line 43. That is, the extension direction of the open end 451 of the second coupling line 45 and the extension direction of the open end 431 of the first coupling line 43 is the same. Also, in some implementations, the included angle between two lines respectively connecting the projections of the two ends of the second coupling line 45 on the feeding substrate 20 to the center of the feeding substrate 20 is 150°-200°, such as 180°, so that the circularly polarized antenna 200 has a good circular polarization effect. In some embodiments, the length of the second coupling line 45 is one-fourth of λ2, where λ2 is the wavelength of a second signal, such that the second signal can be received or sent through the second coupling line 45. Λ2 is also referred to as a second operation wavelength of the circularly polarized antenna. In some embodiments, the second signal is a signal with a signal frequency of about 2.4 GHz. It can be understood that, in some other embodiments of the present disclosure, the second signal may be a signal with another frequency to meet actual needs. The length of the second coupling line 45 is greater than the length of the first coupling line 43. In some embodiments, the radiation element 40 includes the first coupling line 43 for receiving or sending signals with frequency of about 5.8 GHz and the second coupling line 45 for receiving or sending signals with frequency of about 2.4 GHz, such that the circularly polarized antenna 200 is a dual-frequency circularly polarized antenna which can cover a wide communication frequency band and has a better practical value. Further, the length of the second coupling line 45 is greater than the length of the first coupling line 43, and the radial dimension of the circularly polarized antenna is affected by the size of the balun structure such that the radial dimensions of the circularly polarized antenna 200 and the circularly polarized antenna 100 are the same. Therefore, when the length of the second coupling line 45 is greater than the length of the first coupling line 43, the axial height of the circularly polarized antenna 100 is smaller than the axial height of the circularly polarized antenna 200. That is, the volume of the circularly polarized antenna 100 is smaller than the volume of the circularly polarized antenna 200. In some embodiments of the present disclosure, the circularly polarized antenna 200 further includes a second microstrip line connecting the second coupling line 45 and the microstrip line 44.

In some embodiments, the second coupling line 45 is spaced apart from the first coupling line 43, and the second coupling line 45 is closer to the feeding substrate 20 as compared to the first coupling line 43, which reduces coupling inside the circularly polarized antenna 200. It can be understood that, in some other embodiments of the present disclosure, the second coupling line 45 may also be farther away from the feeding substrate 20 as compared to the first coupling line 43.

In some embodiments, the extension direction of the microstrip line 44 is the same as the axial direction of the dielectric cylinder 10, and both the first coupling line 43 and the second coupling line 45 intersect with the microstrip line 44. It is understandable that, in some other embodiments of the present disclosure, the extension direction of the microstrip line 44 can also be perpendicular to the axial direction of the dielectric cylinder 10 and be along the circumferential direction of the dielectric cylinder 10 or in any other direction.

In the present disclosure, each radiation element 40 can be fed with the same amplitude in the same direction through the feeding network 30. Specifically, a signal of an external device is transmitted to the feeding network 30 through the feeding port 31, and then transmitted to the radiation element 40 through the feeding network 30 and sent out through the radiation element 40; or the radiation element 40 receives a circularly polarized wave and transmits the received signal to the feeding port 31 through the feeding network 30, and then transmits to the external device through the feeding port 31.

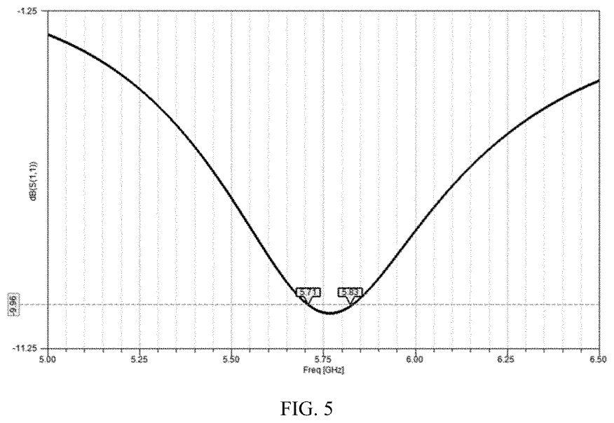

Referring to FIG. 5, the abscissa is frequency (GHz), and the ordinate is parameter S11 (dB). By testing the S11 values of the communication signals of the circularly polarized antenna 100 at different frequencies, it can be seen that the circularly polarized antenna 100 achieves S11<−10 dB at 5.71-5.83 GHz. It means that the circularly polarized antenna 100 has good single-frequency matching characteristics around 5.8 GHz, and can well receive or send signals with a frequency of about 5.8 GHz, which meets actual needs.

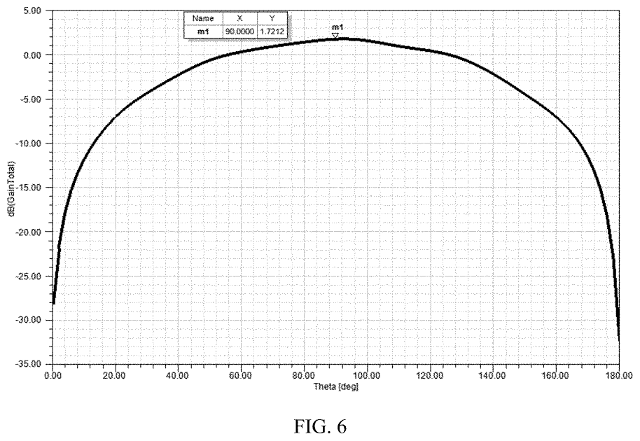

Referring to FIG. 6, the abscissa is angle Theta (deg), and the ordinate is total gain GainTotal (dB). By testing the E-plane total gain of the circularly polarized antenna 100 for each angle at 5.8 GHz, it can be seen that the E-plane total gain of the circularly polarized antenna 100 reaches 1.7212 dB at 5.8 GHz, with good signal quality. In addition, the maximum gain is achieved at 90° position, indicating that the circularly polarized antenna 100 has good omnidirectionality.

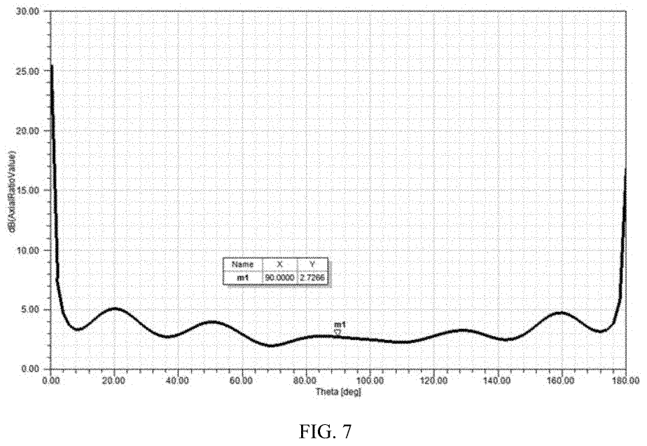

Referring to FIG. 7, the abscissa is angle Theta (deg), and the ordinate is axial ratio AxialRatioValue (dB). By testing the E-plane axial ratio of the circularly polarized antenna 100 for each angle at 5.8 GHz, it can be seen that in the direction of maximum gain (90° position in this embodiment), the axial ratio is 2.7266 dB, which is less than 3 dB. It means that the circularly polarized antenna 100 has good circular polarization characteristics and meets the requirements of a circularly polarized antenna.

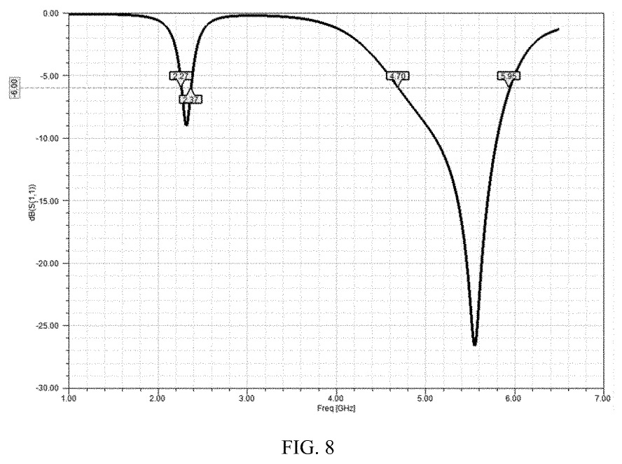

Referring to FIG. 8, the abscissa is frequency (GHz), and the ordinate is parameter S11 (dB). By testing the S11 values of the communication signals of the circularly polarized antenna 200 at different frequencies, it can be seen that the circularly polarized antenna 200 achieves S11<−6 dB at 2.27-2.37 GHz and 4.7-5.95 GHz. It means that the circularly polarized antenna 200 has good matching characteristics around 2.4 GHz and 5.8 GHz and achieves good dual-frequency matching characteristics. It can well receive or send signals with frequencies of about 2.4 GHz and about 5.8 GHz, which meets actual needs. Also, it can be seen from FIG. 8 that the circularly polarized antenna 200 achieves a wide frequency around 5.8 GHz.

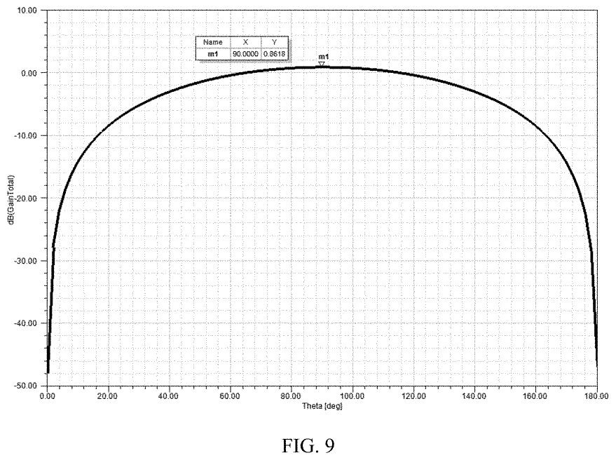

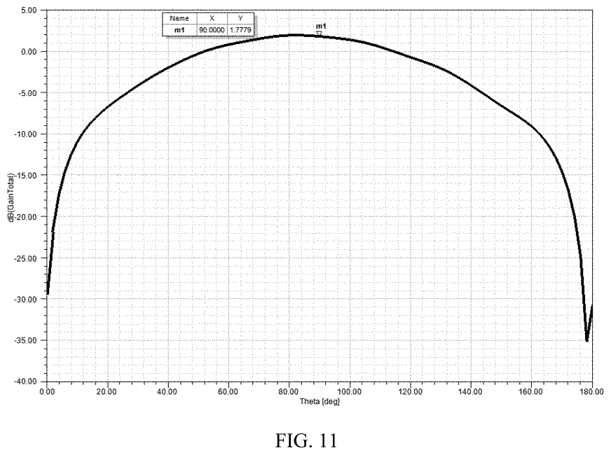

Referring to FIG. 9 and FIG. 11, the abscissa is angle Theta (deg) and the ordinate is total gain GainTotal (dB). By testing the E-plane total gain of the circularly polarized antenna 200 for each angle at 2.4 GHz and 5.8 GHz, it can be seen that the E-plane total gain of the circularly polarized antenna 200 reaches 0.862 dB at 2.4 GHz and 1.778 dB at 5.8 GHz. It means that the circularly polarized antenna 200 can receive or send signals around 2.4 GHz and signals around 5.8 GHz, with good signal quality. In addition, the circularly polarized antenna 200 achieves the maximum gain at 90° position, indicating that the circularly polarized antenna 200 has good omnidirectionality.

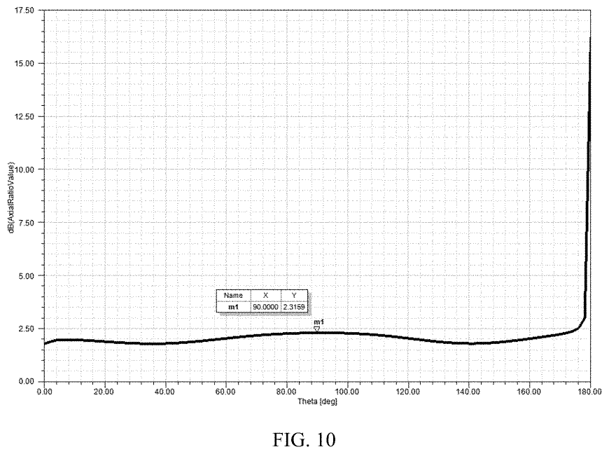

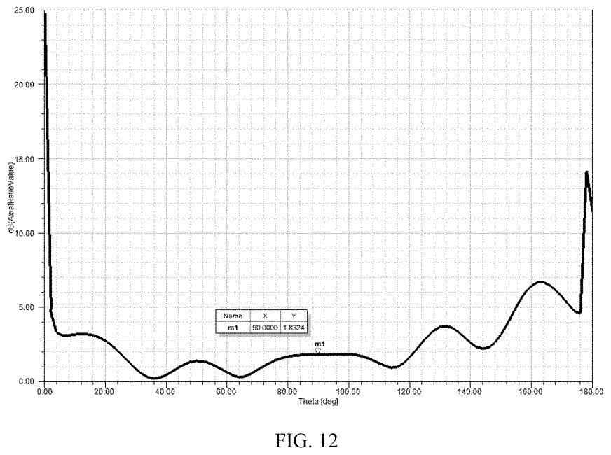

Referring to FIG. 10 and FIG. 12, the abscissa is angle Theta (deg) and the ordinate is axial ratio AxialRatioValue (dB). By testing the E-plane axial ratios of the circularly polarized antenna 200 for each angle at 2.4 GHz and 5.8 GHz, it can be seen that in the direction of maximum gain (90° position in this embodiment), the axial ratios are 2.316 dB and 1.8324 dB, respectively, both are less than 3 dB. It means that the circularly polarized antenna 200 has good circular polarization characteristics at 2.4 GHz and 5.8 GHz, and meets the requirements of a circularly polarized antenna.

In the circularly polarized antenna (including the single-frequency circularly polarized antenna 100 and the dual-frequency circularly polarized antenna 200) provided by the present disclosure, the feeding substrate 20 is arranged in the dielectric cylinder 10, and the feeding network 30 is arranged at the feeding substrate 20, so that the radial dimension of the circularly polarized antenna is mainly determined by the size of the area occupied by the feeding network 30. In the present disclosure, by folding the broadband balun of the feeding network 30, the area occupied by the feeding network 30 is reduced, thereby reducing the radial dimension of the circularly polarized antenna. Also, in some embodiments, the circularly polarized antenna can be designed as a single-frequency antenna or a dual-frequency antenna to meet various needs. Further, the circularly polarized antenna has a simple structure and is easy to process. In addition, in the present disclosure, the circularly polarized antenna is obtained through the LDS process, which improves the precision of the circularly polarized antenna and simplifies the manufacturing process. Further, in the present disclosure, both the single-frequency circularly polarized antenna 100 and the dual-frequency circularly polarized antenna 200 have good omnidirectional and circular polarization characteristics, and meet the requirements of circularly polarized antennas.

The above are some embodiments of the present disclosure. It should be noted that for those skilled in the art, various improvements and modifications can be made without departing from the principle of the present disclosure. These improvements and modifications are also considered to be within the scope of the present disclosure.

The above are detailed description of a four-arm helical antenna and communication device provided by the present disclosure. Some examples are used in this specification to illustrate the principles and embodiments of the present disclosure. The description of the embodiments is for the purpose of helping to understand the method of this disclosure and its core idea. At the same time, for those of ordinary skill in the art, there will be changes in specific embodiments and application scope according to the idea of this disclosure. In summary, the content of this specification should not be understood as a limitation to the present disclosure.

What is claimed is:

1. A circularly polarized antenna comprising:
a feeding substrate;
a radiation structure including a plurality of radiation elements each having a spiral shape; and
a feeding network including:
a feeding port arranged at the feeding substrate; and
a balun structure arranged at a surface of the feeding substrate and including a plurality of baluns each having a first end electrically coupled to the feeding port and a second end electrically coupled to one of the plurality of radiation elements.

2. The circularly polarized antenna of claim 1, wherein each of the plurality of baluns includes a folded balun.

3. The circularly polarized antenna of claim 2, wherein the folded balun includes a metal strip line including one or more turning points.

4. The circularly polarized antenna of claim 1, wherein:
the radiation structure consists of three radiation elements; and
the balun structure consists of three baluns each electrically coupled to one of the three radiation elements.

5. The circularly polarized antenna of claim 1, wherein:
the surface is a first surface of the feeding substrate;
the balun structure is a first balun structure and the plurality of baluns are a plurality of first baluns;
the plurality of radiation elements are a plurality of first radiation elements arranged to a side of the first surface of the feeding substrate;
the radiation structure further includes a plurality of second radiation elements arranged to a side of a second surface of the feeding substrate that is opposite to the first surface, each of the second radiation elements having a spiral shape; and
the feeding network further includes a second balun structure arranged at the second surface of the feeding substrate and symmetric to the first balun structure, the second balun structure including a plurality of second baluns each having a first end electrically coupled to the feeding port and a second end electrically coupled to one of the plurality of second radiation elements.

6. The circularly polarized antenna of claim 5, wherein:
each of the plurality of first radiation elements is centrosymmetric to a corresponding one of the plurality of second radiation elements.

7. The circularly polarized antenna of claim 1, further comprising:
a dielectric cylinder;
wherein:
the feeding substrate is fixed in the dielectric cylinder; and
the radiation structure is arranged at an outer surface of the dielectric cylinder.

8. The circularly polarized antenna of claim 1, wherein each of the plurality of radiation elements includes a coupling line and a microstrip line electrically coupled to the coupling line, one end of the microstrip line away from the coupling line being electrically coupled to one of the plurality of baluns.

9. The circularly polarized antenna of claim 8, wherein an included angle between two lines respectively connecting projections of two ends of the coupling line on the feeding substrate to a center of the feeding substrate is 70°-110°.

10. The circularly polarized antenna of claim 8, wherein a length of the coupling line is one-fourth of an operation wavelength of the circularly polarized antenna.

11. The circularly polarized antenna of claim 8, wherein:
the coupling line is a first coupling line;
each of the plurality of radiation elements further includes a second coupling line having a same spiral direction as the first coupling line and a different length than the first coupling line, one end of the second coupling line being electrically coupled to the microstrip line; and
each of the first coupling line and the second coupling line includes an open end away from the microstrip line, an extension direction of the open end of the second coupling line being same as an extension direction of the open end of the first coupling line.

12. The circularly polarized antenna of claim 11, wherein the second coupling line is closer to the feeding substrate as compared to the first coupling line.

13. The circularly polarized antenna of claim 11, wherein:
a length of the first coupling line is one-fourth of a first operation wavelength of the circularly polarized antenna; and
a length of the second coupling line is one-fourth of a second operation wavelength of the circularly polarized antenna, the second operation wavelength being different from the first operation wavelength.

14. The circularly polarized antenna of claim 11, wherein an included angle between two lines respectively connecting projections of two ends of the second coupling line on the feeding substrate to a center of the feeding substrate is 150°-200°.

15. The circularly polarized antenna of claim 1, wherein the circularly polarized antenna is a laser direct structuring (LDS) antenna.

16. The circularly polarized antenna of claim 1, wherein:
the feeding port includes a coaxial feeding port electrically coupled to a coaxial line including an inner conductor layer and an outer conductor layer sheathed outside the inner conductor layer and insulated from the inner conductor layer; and
the inner conductor layer is configured to transmit radiation signals and the outer conductor layer is grounded.
